(19) United States
(12) Patent Application Publication
(10) Pub. No.: US 2026/0111283 A1
(43) Pub. Date: Apr. 23, 2026

(54) SYSTEMS AND METHODS FOR MANAGING HOSTED APPLICATIONS

(71) Applicant: Dell Products L.P., Round Rock, TX (US)

(72) Inventors: GOKUL THIRUCHENGODE VAJRAVEL, Bangalore (IN); MOHIT ARORA, Frisco, TX (US); VINODKUMAR VASUDEV OTTAR, McKinney, TX (US); RICHARD M. TONRY, Georgetown, TX (US); BASSEM EL-AZZAMI, Austin, TX (US); ABEYE TESHOME, Austin, TX (US); LUIS ANTONIO VALENCIA REYES, Waxahachie, TX (US); ADOLFO SANDOR MONTERO, Pflugerville, TX (US); RAJARAVI CHANDRA KOLLARAPU, Allen, TX (US)

(21) Appl. No.: 18/920,035

(22) Filed: Oct. 18, 2024

(51) Int. Cl. G06F 9/50; G06F 8/61

(52) U.S. Cl. CPC G06F 9/5055; G06F 8/61

(57) ABSTRACT

Methods and systems for managing operation of a data processing system are disclosed. To manage operation of the data processing system, software compliance events may be identified by a management controller of the data processing system. Based on the identified software compliance event, the management controller may generate a virtual entity that hosts natively hosted applications of the data processing system and utilize an observability entity to determine whether required applications are identified in the natively hosted applications. Based on the determination, the management controller may manage installation of any required applications not hosted by hardware resources of the data processing system.

### FIELD

Embodiments disclosed herein relate generally to managing a data processing system. More particularly, embodiments disclosed herein relate to systems and methods for managing operations of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a block diagram illustrating a data processing system in accordance with an embodiment.

FIG. 1C shows a block diagram illustrating a data processing system in accordance with an embodiment.

FIGS. 2A-2C show interaction diagrams in accordance with an embodiment.

FIG. 3 shows a flow diagram illustrating a method of managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing (operation of) data processing systems. The data processing systems may provide computer implemented services to users of the data processing systems. The computer implemented services may include any quantity and type of such services. To provide the computer implemented services, data processing systems may include any number of hardware resources (e.g., processors, memory modules, storage devices, communication device, etc.). The hardware resources may support execution of any number and types of applications (e.g., software resources). The software resources may facilitate various types of different computer implemented services to be provided to an end user of the data processing system and may be installed, for example, by a manufacturer of the data processing system in order to enhance the end user's experience during operation of the data processing system.

For example, prior to selling and shipping a data processing system to an end user, a manufacturer may install certain applications on the hardware resources (of the data processing system) that provides additional supportive services for the end user of the data processing system.

Modifications to the hardware and/or software resources of the data processing system may cause the computer-implemented services to not be provided to the end user as desired by, for example, the manufacturer of the data processing system. Specifically, value added software installed on the hardware resources may be wiped/removed from the hardware resources by an end user of the data processing system.

For example, removal of the value added software may be initiated (e.g., inadvertently or deliberately) by a new owner upon physical receipt of the data processing system and during onboarding of the data processing system. The removal of the value added software may limit the functionality of the hardware resources to provide the computer implemented services as desired by the end user, restrict ability of the manufacturer and/or another authorized management system to verify continued quality operations of the data processing system, etc.

Thus, to detect and/or confirm installation of the value added software after physical receipt of the data processing system by the end user, a management controller of the data processing system may initiate generation of virtual machines (e.g., hosted by hardware resources of the data processing system). The virtual machines may be generated based on the natively hosted applications installed on the hardware resources of the data processing system. After generation of the virtual machines, the management controller may communicate, via out-of-band communication channels, with the virtual machines to identify whether the value added software is installed on the hardware resources of the data processing system. Consequently, if the value added software is determined to not be hosted by the hardware resources, the management controller may initiate installation of the value added software to the hardware resources via the virtual machines.

By doing so, installation of the value added software on the data processing system may be managed without violating any applicable security policies (e.g., of the operating system vendor, of the new owner, etc.). Thus, the computer implemented services may be more likely to be provided as desired to the end user of the computer implemented services.

In an embodiment, a method for managing operation of a data processing system is provided. The method may include: identifying, by a management controller of the data processing system, that a software compliance event for hardware resources of the data processing system has occurred; based on the identifying of the software compliance event: identifying, by the management controller and using an observability entity, a list of applications hosted by the hardware resources; comparing, by the management controller, the list of applications to a required list of applications to identify whether any required applications are not hosted by the hardware resources; in an instance of the comparing where at least one of the required applications is not hosted by the hardware resources: initiating, by the management controller, installation of at least one of the required applications that is not hosted by the hardware resources to place the hardware resources into compliance with the required applications; and providing, by the hardware resources, at least a portion of computer implemented services using the at least one of the required applications.

The required list of applications may be based on applications installed on the hardware resources when the data processing system is manufactured.

The identifying that the software compliance event may be performed after the data processing system is sold by a manufacturer to an end user.

The end user may be a legal entity, and an onboarding process may be performed by an agent of the legal entity to initiate use of the data processing system by the end user.

The onboarding process may include removing, at least, the at least one of the required applications from hosting by the hardware resources.

The method may include: after the identifying the occurrence of the software compliance event and prior to identifying the list of applications: initiating, by the management controller, performance of a conversion of natively hosted applications by the hardware resources to hosting in a new virtual entity.

Identifying the list of applications may include: reading, by the observability entity, an image of the new virtual entity to identify each application hosted by the new virtual entity.

The occurrence of the software compliance event may be a startup of the data processing system after completing onboarding to a domain of a new owner of the data processing system.

The new virtual entity is a virtual machine, the reading of the image is facilitated by a hypervisor hosted by the hardware resources, and the hypervisor is adapted to manage resource access by the virtual machine and the observability entity.

The data processing system may include a network module adapted to separately advertise network endpoints for the management controller and hardware resources of the data processing system, the network endpoints being usable by a server to address communications to the hardware resources using an in-band communication channel and the management controller using an out-of-band communication channel.

The management controller and the network module may be on separate power domains from the hardware resources so that the management controller and the network module may be operable while the hardware resources are inoperable.

The out-of-band communication channel may run through the network module, and the in-band communication channel that services the hardware resources may also run through the network module.

The network module may host a transmission control protocol/internet protocol (TCP/IP) stack to facilitate network communications via the out-of-band communication channel.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

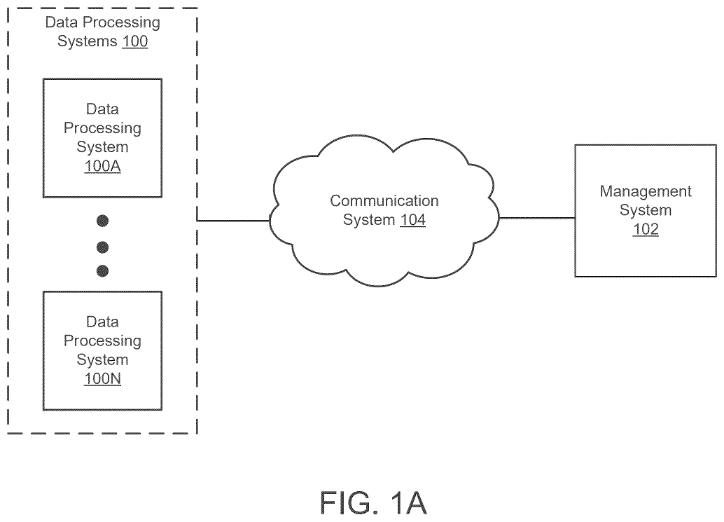

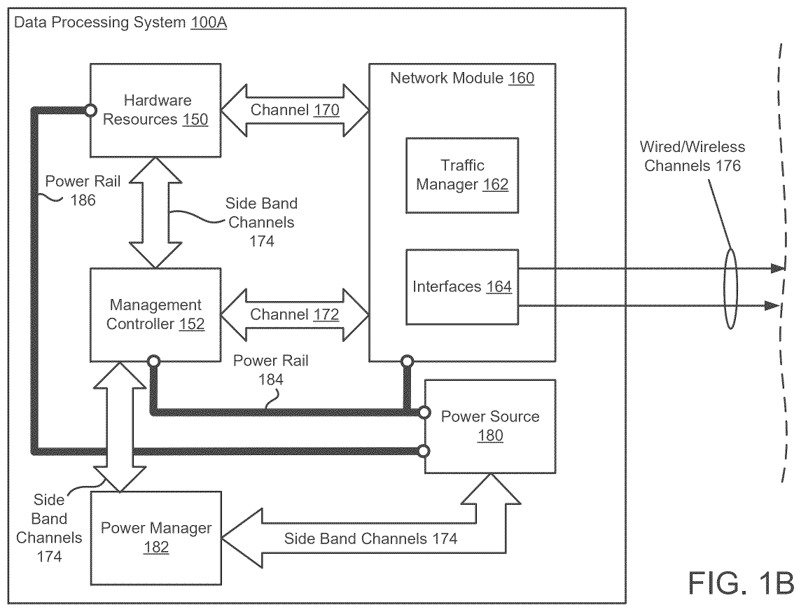

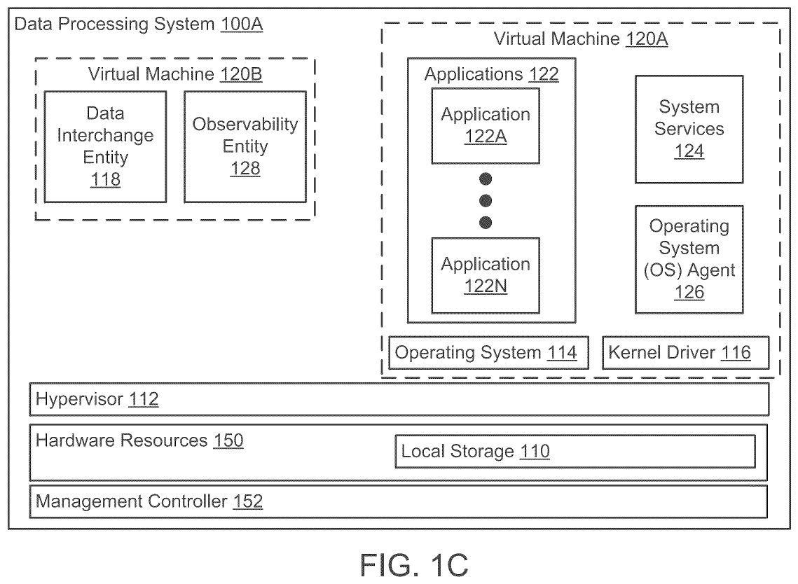

Turning to FIG. 1A, a block diagram illustrating a system in accordance with an embodiment is shown. The system shown in FIG. 1A may provide for management of data processing systems that may provide, at least in part, computer-implemented services. The system may include any number of data processing systems 100 (e.g., computing devices) that may each include any number of hardware components (e.g., processors, memory modules, storage devices, communications devices). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

Operation of and/or computer implemented services provided by a data processing system (e.g., data processing system 100A) may be negatively impacted if modifications (e.g., to hardware and/or software components of the data processing system) occur. For example, a manufacturer of data processing system 100A may install applications on the hardware resources of data processing system 100A (e.g., to support functionality of the hardware resources, to provide additional services to an end user operating the data processing system, etc.) prior to physical possession of data processing system 100A by an end user. However, the manufacturer's originally installed applications may be ineffective if, for example, removed by an end user (e.g., inadvertently and/or intentionally) upon physical receipt of data processing system 100A.

Software components installed on data processing systems 100 may be modified during, for example, onboarding processes performed by new owners and/or end users of data processing systems 100. Consider a scenario in which a manufacturer's applications have been installed on hardware resources of data processing system 100A and data processing system 100A has been purchased and/or shipped to an end user (e.g., customer). Upon physical possession of data processing system 100A by the end user, an onboarding process of data processing system 100A may be performed (e.g., by the end user and/or administrator of the data processing system).

During onboarding of data processing system 100A, modifications including removal of previously installed software resources (e.g., manufacturer installed required applications) and/or installation of other software resources (e.g., user preferred software resources) on data processing system 100A may be implemented. For example, the end user may wipe all software resources (e.g., operating system, applications, etc.) installed on data processing system 100A by the manufacturer and selectively install new software resources (e.g., new operating system, applications, etc.) as preferred by the end user.

In addition, the manufacturer applications may be required to be installed on hardware resources of data processing system 100A in order to support functionality of hardware resources, facilitate management of operations of data processing system 100A, and may be unintentionally and/or inadvertently removed by the end user while onboarding data processing system 100A.

Removal of the (manufacturer) required software resources from data processing system 100A may lead to limited functionality of hardware resources of data processing system, disable management services to be provided (e.g., by the manufacturer), computer implemented services not being provided by data processing system 100A as desired, etc. For example, installation of the required software resources may be necessary for effective management of operation of the data processing systems. For example, the required software resources may include an agent (e.g., executing program hosted by an operating system of data processing system 100A) capable of sharing information (e.g., regarding operation of the hardware and/or software resources of data processing system 100A) to an external entity, such as a management system. By removing the agent (e.g., wiping the required software resources originally installed) from data processing system 100A, the management system may be unable to access information necessary to effectively manage operations of the data processing system.

In general, embodiments disclosed herein relate to systems and methods for managing operation of a data processing system. The data processing system may include a management controller that may utilize out-of-band communication channels to obtain information necessary to generate and/or manage virtual machines that host natively hosted applications of the hardware resources of the data processing system. The management controller may utilize the virtual machines to enforce implementation of required applications on the data processing system after identifying an occurrence of a software compliance event.

To do so, the management controller may convert the natively hosted applications of the hardware resources to a new virtual entity and utilize an observability entity (e.g., another virtual entity) to identify whether the natively hosted applications installed on the hardware resources of the data processing system include the required applications. If at least one of the required applications is not hosted by the hardware resources, the management controller may initiate installation of the required application(s) on the operating system of the new virtual entity. By doing so, the hardware resources of the data processing system may include the required applications usable to provide computer implemented services as desired.

To perform the above-mentioned functionality, the system of FIG. 1A may include data processing systems 100 and/or management system 102. Data processing system 100, management system 102, and/or any other type of devices not shown in FIG. 1A may perform all, or a portion of the computer-implemented services independently and/or cooperatively. Each of these components is discussed below.

Data processing systems 100 may include any number and/or type of data processing systems (e.g., other data processing systems, management systems, storage devices, user devices, etc.) that may provide computer implemented services. To do so, each of data processing systems 100A-100N may include out-of-band components (e.g., a network module, a management controller, etc.), and functionality that may allow data exchange between the out-of-band components independently from in-band components of data processing systems 100A-100N. For more information regarding out-of-band components of data processing systems 100, refer to the discussion of FIG. 1B.

For example, the out-of-band components of data processing systems 100 may identify an occurrence of a software compliance event and enforce implementation of the required applications to place the hardware resources into compliance (if the hardware resources are determined not to be incompliance). Enforcing implementation of the required applications may be facilitated by (i) initiating, by the management controller, performance of a conversion of natively hosted applications (e.g., by hardware resources of the data processing system) to hosting a new virtual entity, (ii) generating an observability entity (e.g., another virtual entity) based on the new virtual entity, (iii) identifying, by the management controller and using the observability entity, a list of applications hosted by the hardware resources, (iv) determining whether any of the required applications are not hosted by the hardware resources, and/or (v) based on at least one of the required applications not being hosted by the hardware resources, initiating installation of the at least one of the required applications using out-of-band methods.

Management system 102 may manage the operation of data processing systems 100 (e.g., 100A-100N). To perform its functionality, management system 102 may communicate (e.g., exchange data) with the out-of-band components of data processing systems 100 using out-of-band communication channels. For example, to manage the operation of the data processing systems, management system 102 may provide access to information necessary to perform conversion processes of natively hosted applications by hardware resources of the data processing systems to a new virtual entity (e.g., virtual machine, container, any other types of simulations of the data processing systems).

The information for performing the conversion processes may be used, for example, by the management controller of a data processing system (e.g., 100A) to obtain a virtual entity (e.g., virtual machine) that hosts natively hosted applications by the data processing system. Doing so may enable the management controller to determine whether required applications are installed on the data processing system without violating any security policies and/or privacy regulations of data processing systems. Therefore, the computer implemented services provided by the data processing systems may improve and/or be provided to an end user as desired.

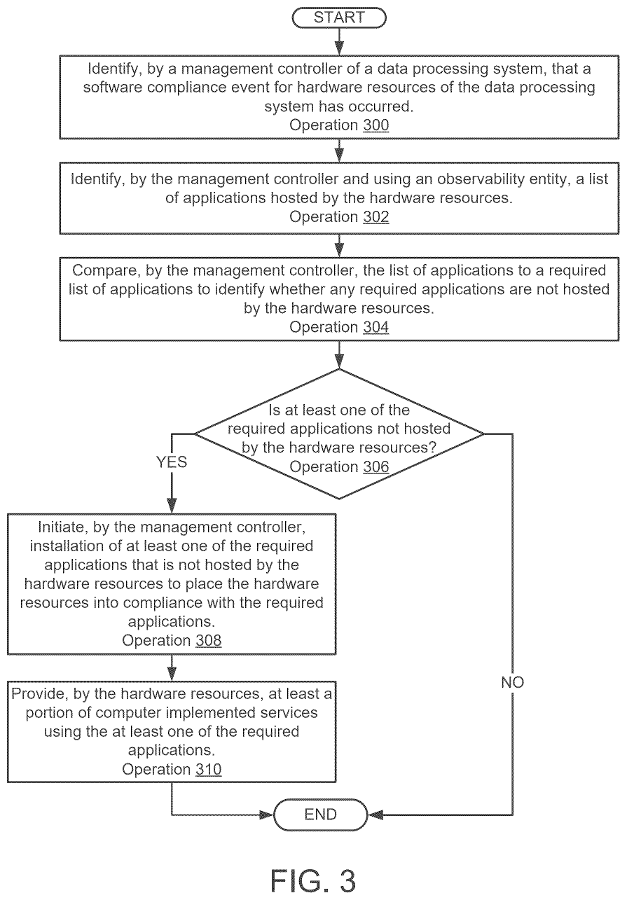

When providing their functionality, any of data processing systems 100, and/or management system 102 may perform all, or a portion of the methods shown in FIG. 3.

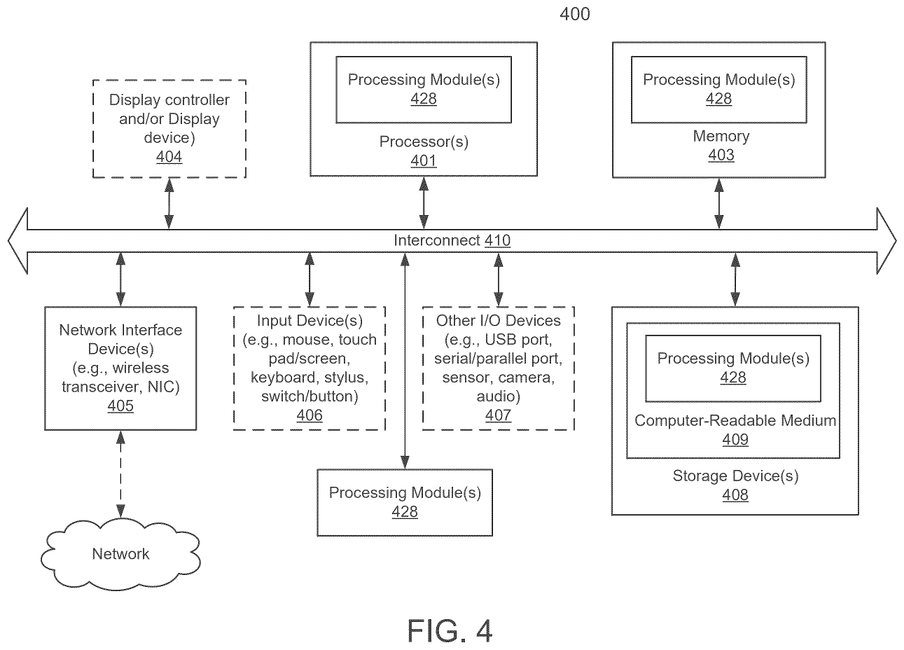

Any of (and/or components thereof) data processing systems 100, and/or management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

In an embodiment, one or more of data processing systems 100, and/or management system 102 are implemented using an internet of things (IoT) device, which may include a computing device. The IoT device may operate in accordance with a communication model and/or management model known to any of data processing systems 100, and/or management system 102, and/or other devices.

Any of the components illustrated in FIG. 1A may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and/or types of communication protocols (e.g., such as the internet protocol). Communication system 104 may include any number of in-band communication channel and/or out-of-band communication channels.

While illustrated in FIG. 1A as including a limited number of specific components, a system in accordance with an embodiment may include fewer, additional, and/or different components than those illustrated therein. For example, while the system of FIG. 1A shows a single management system (e.g., 102), it will be appreciated that the system may include any number of management systems.

Turning to FIG. 1B, a diagram illustrating data processing system 100A in accordance with an embodiment is shown. Data processing system 100A may be similar to any of data processing systems 100 shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components. Hardware resources 150 may (e.g., via the processor) provide the computer-implemented services desired by users of data processing system 100A.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 100A may include management controller 152 and network module 160. Each of these components of data processing system 100A is discussed below.

Management controller 152 may operate independently from hardware resources 150 and, therefore, hardware resources 150 may not host and/or manage operation of management controller 152. In addition, management controller 152 may be distinct from hardware resources 150 and, therefore, may be physically separate from hardware resources 150. Management controller 152 may also be operably connected to communication components of data processing system 100A via separate channels (e.g., 172) from the in-band components.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band component, may manage power distribution, thermal management, and/or other functions of data processing system 100A.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

Information provided to the application by management controller 152 may include, for example, instructions for implementation of computer-implemented services desired by users of data processing system 100A.

To facilitate communication with other devices, data processing system 100A may include network module 160. Network module 160 may provide communication services for in-band components and out-of-band components (e.g., management controller 152) of data processing system 100A.

To provide the above-described functionalities, network module 160 may include traffic manager 162, interfaces 164, and may host an instance of a TCP/IP stack to facilitate communication with other devices independently of any of the in-band components (e.g., does not rely on any hosted software, hardware components, etc.). Accordingly, compromise of any of hardware resources 150 and hosted component may not result in indirect compromise of network module 160, management controller 152, and entities hosted by management controller 152.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

Network module 160 may utilize the instance of the TCP/IP stack to allow hardware resources 150 and/or management controller 152 to communicate with other devices via packet switched networks and/or other types of communication networks.

To facilitate management of data processing system 140 over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails (e.g., by providing instructions via side band channels 174).

Management controller 152 may cooperate with power manager 182 to manage supply of power to these power domains. Management controller 152 may communicate with power manager 182 via side band channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

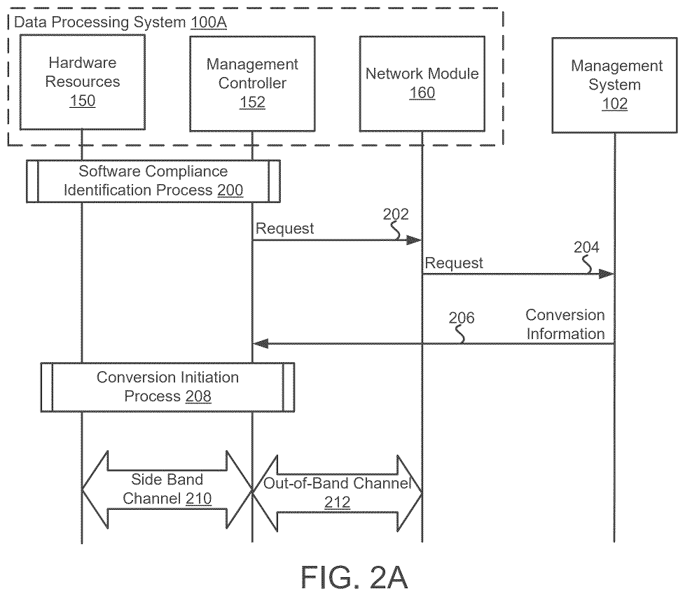

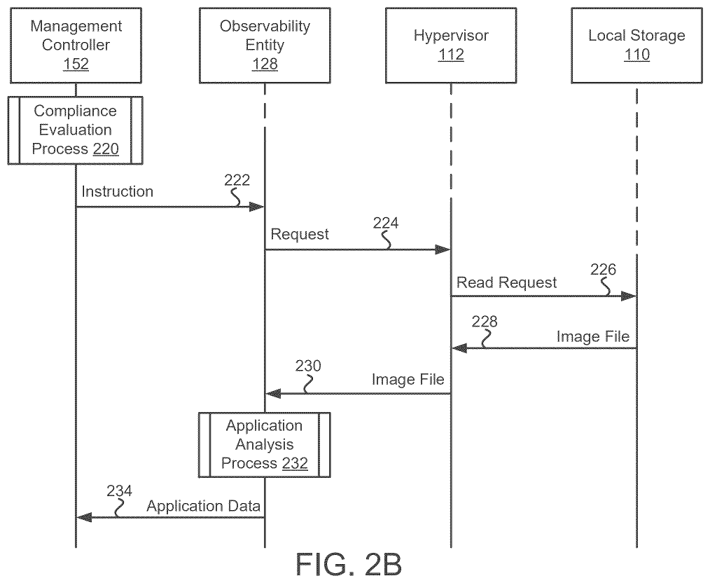

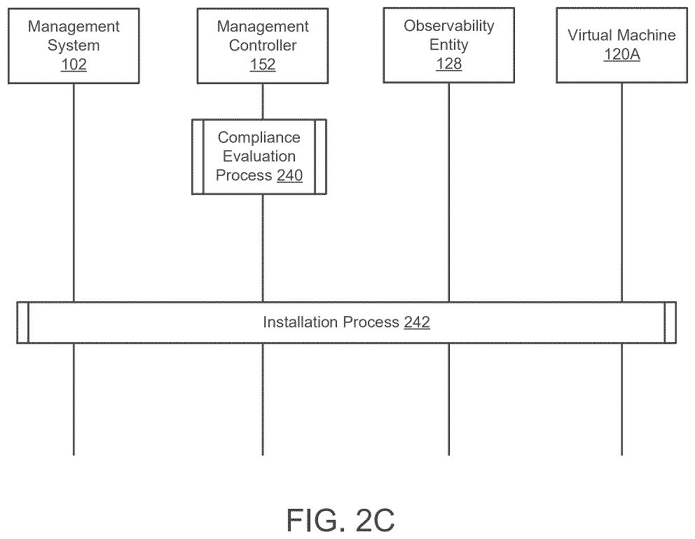

When providing its functionality, management controller 152 may perform all, or a portion, of the methods and operations described in FIGS. 2A-2C.

While illustrated in FIG. 1B with a limited number of specific components, a system may include additional, fewer, and/or different components without departing from embodiments disclosed herein.

Turning to FIG. 1C, a diagram illustrating data processing system 100A in accordance with an embodiment is shown.

To provide computer implemented services, data processing system 100A may include any quantity of hardware resources 150. Hardware resources 150 may include physical parts of data processing system 100A that store and run software. Hardware resources 150 may include a motherboard, central processing unit (CPU), disk storage device, memory, etc. Hardware resources 150 may host local storage 110 (e.g., local storage device).

Local storage 110 may be physical connected to the motherboard to receive power and enable operation of local storage 110. Local storage 110 may store data usable to facilitate operations of operating system 114 and applications 122.

Operating system 114 may manage local storage 110 by organizing the data into files and directories to facilitate efficient retrieval and storage of the data. Operating system 114 may interface between hardware resources 150 (including local storage 110) and any software (e.g., applications 122) in data processing system 100A.

Applications 122 may host any number of applications (e.g., 122A-122N). Applications 122 may receive information from operating system 114 such as, instructions for implementation of various types of computer implemented services.

To manage operation of data processing system 100A, data processing system 100A may include management controller 152. Management controller 152 may provide various management functionalities for data processing system 100A. For example, management controller 152 may monitor various ongoing processes performed by any of in-band components (e.g., hardware resources 150, local storage 110, operating system 114, etc.). Management controller 152 may be similar to management controller 152 described and shown in FIG. 1B. To facilitate management of operating system 114, management controller 152 may communicate data with operating system (OS) agent 126.

OS agent 126 may provide communications between operating system 114 and management controller 152. However, OS agent 126 may become disabled and/or have limited functionality due to various reasons (e.g., removal of the software component and/or functionality supportive components). As such, OS agent 126 may be unable to facilitate communications between operating system 114 and management controller 152.

In order to facilitate communicate between management controller 152 and software resources (e.g., operating system 114, applications 122, etc.) of data processing system 100A, management controller 152 may perform a conversion process of natively hosted applications (e.g., applications 122) of data processing system 100A to a virtual entity (e.g., virtual machine 120A). For example, management controller 152 may obtain information from an external entity (e.g., management system 102) necessary to perform the conversion process. To perform the conversion process, management controller 152 may copy the contents of software resources (e.g., operating system 114, applications 122, and/or any other data) and create an image file containing the contents of the software resources. The image file may be stored by hardware resources 150 of data processing system 100A and may be accessible by components of data processing system 100A.

To facilitate accessibility to the image file by management controller 152, data processing system 100A may include hypervisor 112. Hypervisor 112 may include a software component that creates and manages virtual machines (e.g., virtual machines 120A-120B) on data processing system 100A. To do so, hypervisor 112 may provide access to computing resources provided by hardware resources 150. For example, hypervisor 112 may provide time sliced access to the computing resources. Hypervisor 112 may provide the time sliced access to virtual machines (e.g., 120A-120B).

Virtual machines 120A-120B may host an operating system and one or more applications that are natively hosted by data processing system 100A. Additionally, virtual machine 120B may host an agent, observability entity 128, that may cooperate with management controller 152. Refer to FIG. 2A for additional information regarding obtaining virtual machines.

To manage operation of data processing system 100A, observability entity 128 may facilitate collection of software data. To facilitate collection of software data, virtual machine 120B may first collect the software data regarding a present state of the software components natively hosted by hardware resources 150 of the data processing system 100A. Observability entity 128 may share the software data (e.g., including a list of applications hosted by virtual machine 120A) to management controller 152. By doing so, management controller 152 may analyze the software data to determine whether required applications are installed on data processing system 100A.

Thus, using the architecture illustrated in FIG. 1C, a system in accordance with an embodiment may limit resource consumption while providing software analysis by a management controller of the data processing system.

To further clarify embodiments disclosed herein, interaction diagrams in accordance with an embodiment is shown in FIGS. 2A-2C. The interaction diagrams may illustrate examples of how data may be obtained and used within the systems of FIGS. 1A-1C.

In the interaction diagrams, processes performed by and interactions between components of a system in accordance with an embodiment are shown. In the diagrams, components of the system are illustrated using a first set of shapes (e.g., 152, 154, etc.), located towards the top of each figure. Lines descend from these shapes. Processes performed by the components of the system are illustrated using a second set of shapes (e.g., 200, 208) superimposed over these lines.

Interactions (e.g., communication, data transmissions, etc.) between the components of the system are illustrated using a third set of shapes (e.g., 202, 206, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 204. However, it will be appreciated that the processes and interactions may be performed in different orders, any may be omitted, and other processes or interactions may be performed without departing from embodiments disclosed herein.

The processes shown in FIGS. 2A-2C may be performed by any entity shown in the systems of FIGS. 1A-1C (e.g., a device similar to one of data processing systems 100, management system 102, etc.) and/or another entity without departing from embodiments disclosed herein.

Turning to FIG. 2A, a first interaction diagram in accordance with an embodiment is shown. The first interaction diagram may illustrate processes and interactions that may occur during establishment of an observability entity for a data processing system.

To establish the observability entity, software compliance identification process 200 may be initiated. During software compliance identification process 200, any occurrence of software compliance events may be identified. For example, an occurrence of a software compliance event may include a startup of data processing system 100A (and/or hardware resources 150 of data processing system 100A) after completing onboarding to a domain of a new owner of data processing system 100A. For example, after onboarding of data processing system 100A, management controller 152 may receive signals from hardware resources 150 that signal start up of the system has occurred.

As a result from software compliance identification process 200 and at interaction 202, a request may be generated and provided to network module 160 by management controller 152. For example, the request may be generated and provided to network module 160 via (i) transmission via a message, (ii) storing in a storage with subsequent retrieval by network module 160, (iii) via a publish-subscribe system where network module 160 subscribed to updates from management controller 152 thereby causing a copy of the request to be propagated to network module 160 and/or via other processes. By providing the request to network module 160, network module 160 may receive the request for data processing system 100A in order to provide communication services with external devices.

At interaction 204, the request may be provided to management system 102 by network module 160. For example, the request may be provided to management system 102 via (i) transmission via a message, (ii) storing in a storage with subsequent retrieval by management system 102, (iii) via a publish-subscribe system where management system 102 subscribed to updates from network module thereby causing a copy of the request to be propagated to management system 102 and/or via other processes. By providing the request to management system 102, management system 102 may receive a copy of the request for data processing system 100A in order to provide management services.

Once received, management system 102 may identify information to facilitate conversion of natively hosted applications of data processing system 100A. To do so, management system 102 may perform any type of searching processes including performing a look up process in a database containing conversation information keyed to different data processing systems.

At interaction 206, conversation information may be provided to management controller 152 by management system 102. For example, the conversation information may be provided to management controller 152 via (i) transmission via a message, (ii) storing in a storage with subsequent retrieval by management controller 152, (iii) via a publish-subscribe system where management controller 152 subscribed to updates from management system 102 thereby causing a copy of the conversion information to be propagated to management controller 152 and/or via other processes. By providing the conversion information to management controller 152, management controller 152 may receive a copy of the conversion information for data processing system 100A.

Once obtained, the conversion information may be utilized during performance of conversion initiation process 208. During conversion initiation process 208, management controller 152 may perform any type of conversion processes to convert natively hosted applications (e.g., hosted by hardware resources 150) to host in a new virtual entity (e.g., virtual machine 120A shown in FIG. 1C).

For example, management controller 152 may communicate instructions to hardware resources 150 to generate a copy of the software resources (e.g., operating system, applications, any other software data) hosted by hardware resources 150 and convert it to a virtual machine image file (also herein referred to as “image file”). The virtual machine image file may contain all software data hosted by hardware resources 150 of data processing system 100A. Management controller 152 may utilize a hypervisor to facilitate access to any of virtual machines (e.g., 120A-120B shown in FIG. 1C).

Thus, as shown in the example of FIG. 2A, conversation information may be obtained from authorized devices (e.g., management system 102) using out-of-band methods. By doing so, the conversation information may be utilized by a management controller of the data processing system to generate virtual entities (e.g., virtual machines 120A-120B shown in FIG. 1C) hosting natively hosted applications by the hardware resources of the data processing system without utilizing in-band components.

Turning to FIG. 2B, a second interaction diagram in accordance with an embodiment is shown. The second interaction diagram may illustrate example processes and interactions that may be performed to obtain application data for a data processing system in order to ascertain whether compliant software is hosted (by hardware resources) on the data processing system.

To obtain application data for the data processing system, management controller 152 may perform compliance evaluation process 220. During compliance evaluation process 220, management controller 152 may determine that an evaluation of software resources (e.g., applications hosted by hardware resources of data processing system) is necessary and may identify information needed to perform the evaluation of the software resources.

As part of compliance evaluation process 220, management controller 152 may provide commands to hypervisor 112 to initiate launch of observability entity 128. Hypervisor 112 may allocate hardware resources such as, CPU cycles, memory, storage space, etc. to each virtual machine hosted by data processing system 100A.

To do so, hypervisor 112 may provide launch commands to inactive virtual machines (e.g., observability entity 128) and as a result, observability entity 128 may be launched to provide desired computer implemented services and facilitate collection of application data from the data processing system.

At interaction 222, instruction may be generated and provided to observability entity 128 by management controller 152. For example, the instruction may be provided to observability entity 128 via (i) transmission via a message, (ii) storing in a storage with subsequent retrieval by observability entity 128, (iii) via a publish-subscribe system where observability entity 128 subscribes to updates from management controller 152 thereby causing a copy of the instruction to be propagated to observability entity 128, and/or via other processes. By providing the instruction to observability entity 128, observability entity 128 may receive a copy of the instruction.

At interaction 224, a request may be generated and provided to hypervisor 112 by observability entity 128. For example, the request may be provided to hypervisor 112 via (i) transmission via a message, (ii) storing in a storage with subsequent retrieval by hypervisor 112, (iii) via a publish-subscribe system where hypervisor 112 subscribes to updates from observability entity 128 thereby causing a copy of the request to be propagated to hypervisor 112, and/or via other processes. By providing the request to hypervisor 112, hypervisor 112 may receive a copy of the request and perform an action based on the information contained in the request.

At interaction 226, a read request may be generated and provided to local storage 110 by hypervisor 112. For example, the read request may be generated and provided to local storage 110 via (i) transmission via a message, (ii) storing in a storage with subsequent retrieval by local storage 110, (iii) via a publish-subscribe system where local storage 110 subscribes to updates from hypervisor 112 thereby causing a copy of the read request to be propagated to local storage 110, and/or via other processes. By providing the read request to local storage 110, local storage 110 may receive a copy of the read request and perform an action based on the information contained in the read request. Local storage 110 may read the read request and identify data responsive to the read request.

At interaction 228, an image file may be generated and provided to hypervisor 112 by local storage 110. For example, the image file may be generated and provided to hypervisor 112 via (i) transmission via a message, (ii) storing in a storage with subsequent retrieval by hypervisor 112, (iii) via a publish-subscribe system where hypervisor 112 subscribes to updates from local storage 110 thereby causing a copy of the image file to be propagated to hypervisor 112, and/or via other processes. By providing the image file to hypervisor 112, hypervisor 112 may receive a copy of the image file.

At interaction 230, the image file may be provided to observability entity 128 by hypervisor 112. For example, the image file may be provided to observability entity 128 via (i) transmission via a message, (ii) storing in a storage with subsequent retrieval by observability entity 128, (iii) via a publish-subscribe system where observability entity 128 subscribes to updates from hypervisor 112 thereby causing a copy of the image file to be propagated to observability entity 128, and/or via other processes. By providing the image file to observability entity 128, observability entity 128 may receive a copy of the image file.

Upon receipt of the image file, observability entity 128 may perform application analysis process 232. During application analysis process 232, observability entity 128 may analyze the image file to identify a list of applications hosted by the hardware resources of data processing system 100A. To do so, observability entity 128 may perform any type of identification processes to identify data related to applications (e.g., hosted by hardware resources of the data processing system) and compile the data to generate a list of the applications.

At interaction 234, the application data may be provided to management controller 152 by observability entity 128. The application data may be sent by an inter-process communication method, such as, for example, shared memory, sockets, pipes, message queues, etc. using an out-of-band communication channel (e.g., similar to out-of-band channel 172 shown and described in FIG. 1B). Once the application data has been received by management controller 152, management controller 152 may utilize the application data to complete the compliance evaluation process. Refer to FIG. 2C for additional information regarding performance of compliance evaluation process by a management controller of a data processing system.

Thus, as shown in the example of FIG. 2B, application data of natively hosted applications of a data processing system may be obtained from an observability entity (e.g., observability entity 128) using out-of-band methods. By doing so, the application data may be provided to a management controller of the data processing system without utilizing in-band components and/or without requiring functionality of the data processing system (e.g., powered on, network connection, etc.) Turning to FIG. 2C, a third interaction diagram in accordance with an embodiment is shown. The third interaction diagram may illustrate example processes and interactions that may occur during evaluation and installation of software resources for a data processing system.

To evaluate compliance of software resources, compliance evaluation process 240 may be performed. During compliance evaluation process 240, management controller 152 may utilize application data (e.g., obtained during processes performed and described in FIG. 2B) to evaluate whether required applications are a part of the application data hosted by hardware resources (e.g., 150) of data processing system 100A.

Installation process 242 may be initiated by management controller 152 and may be performed cooperatively with other components of the system (e.g., management system 102, observability entity 128, virtual machine 120A, and/or other components not shown in FIG. 2C). During installation process 242, installation of at least one of the required applications that is not hosted by the hardware resources may be initiated in order to place the hardware resources into compliance with the required applications.

As part of installation process 242, a copy of the required applications (e.g., application data) may be obtained from an external management entity (e.g., management system 102). The copy of the required applications may be obtained by various methods. For example, management controller 152 may generate and provide instructions to observability entity 128 via an out-of-band communication channel. Upon receipt of the instructions, observability entity 128 may communicate with management system 102 to obtain a copy of the required applications directly from management system 102.

As an additional example, management controller 152 may obtain the copy of the required applications (e.g., the required application data) directly from management system 102 and upon receipt of the required applications, management controller 152 may provide a message (e.g., including the required applications and instructions to install the required applications on the operating system of virtual machine 120A) to observability entity 128. Once received, observability entity 128 may initiate installation of the required applications on the operating system of virtual machine 120A.

As a result of performing installation process 242, the operation of data processing system 100A may be updated to provide (using the hardware resources) at least a portion of computer implemented services using the at least one of the required applications.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2C may perform various methods to identify installation of required applications hosted by hardware resources of a data processing system using out-of-band methods and based on an occurrence of a software compliance event. The data processing system may include out-of-band components that may obtain information necessary to generate and/or manage virtual entities (e.g., virtual machines) that host natively hosted applications of the hardware resources of the data processing system. By utilizing out-of-band components and virtual entities, identification of any required applications not hosted by the hardware resources may be identified and installation of the required applications to place the hardware resources into compliance may be managed without violating any applicable security policies (e.g., established by the operating system vendor, the new owner of the data processing system, etc.). Thus, the computer implemented services may be more likely to be provided as desired to the end user of the data processing system.

FIG. 3 illustrates a method that may be performed by the components of the system of FIGS. 1A-2C. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system and/or another device.

Turning to FIG. 3, a flow diagram illustrating a method of managing a data processing system in accordance with an embodiment is shown. The method may be performed, for example, by a data processing system, a management system, a communication system, a management controller, hardware resources, and/or other components illustrated in FIGS. 1A-2C.

At operation 300, a software compliance event for hardware resources of a data processing system has occurred may be identified by a management controller of the data processing system. The software compliance event may be identified via (i) performing an onboarding process of the data processing system, (ii) performing a compliance operation monitoring processing of the data processing system, and/or (iii) by any other methods.

For example, identifying that the software compliance event has occurred may be performed during the onboarding process (e.g., performed by an end user and/or an agent of a legal entity) to initiate use of the data processing system by the end user.

After operation 300 and prior to operation 302, the method may include initiating performance of a conversion of natively hosted applications by the hardware resources to hosting in a new virtual entity. Performance of the conversion of the natively hosted applications may be initiated by (i) obtaining, by the management controller, information and/or data usable to convert natively hosted applications of the data processing system, (ii) generating, by the management controller and using the information and/or data, a copy of software data (e.g., operating system, application data, etc.) and storing the copy as an image file in the hardware resources, (iii) generating the observability entity using the image file, and/or (iv) by any other methods.

At operation 302, a list of applications hosted by the hardware resources may be identified by the management controller and using an observability entity. The list of applications may be identified via (i) reading from storage, (ii) receiving the list from another device, (iii) generating the list of applications, and/or by any other methods. For example, the list of applications may be identified by reading, by the observability entity, an image of the new virtual entity to identify each application hosted by the new virtual entity. Each application identified from the image of the new virtual entity may be aggregated into a list of applications and provided to management controller.

At operation 304, the list of applications may be compared to a required list of applications to identify whether any required applications are not hosted by the hardware resources. The list of applications may be compared to the required list of applications by the management controller via (i) performing a comparison process using the list of applications and the required list of applications, (ii) identifying, if any, the required applications not included in the list of applications, and/or (iii) by any other methods.

At operation 306, a determination is made whether at least one of the required applications is not hosted by the hardware resources. The determination may be made based on the result from performing the comparison process described in operation 304.

If it is determined that the required applications are hosted by the hardware resources (e.g., the determination is “No” at operation 206), then the method may end following operation 306.

Returning to operation 306, if it is determined that at least one of the required applications is not hosted by the hardware resources (e.g., the determination is “Yes” at operation 306), then the method may proceed to operation 308.

At operation 308, installation of at least one of the required applications that is not hosted by the hardware resources may be initiated. Installation of the at least one of the required applications may be initiated by the management controller to place the hardware resources into compliance with the required applications. Installation of the at least one of the required applications that is not hosted by the hardware resources may be initiated via (i) obtaining a copy of the required application (e.g., not hosted by the hardware resources) data and/or any other information from an external entity (e.g., management system 102), (ii) initiating the installation of the required application data on an operating system of the new virtual entity, and/or (iii) performing any other methods.

Obtaining a copy of the required application data (not hosted by the hardware resources) may be facilitated via (i) obtaining, by the management controller, the copy of the required application data from an external entity (e.g., management system 102), (ii) providing, by the management controller, instructions to the observability entity for obtaining the copy of the required application data from the external entity, and/or (iii) performing any other methods.

Initiating the installation of the required application data may be facilitated via (i) providing, by the management controller, instructions and the copy of the required application data to the observability entity, (ii) installing, by the observability entity, the copy of the required application data on the operating system of the new virtual entity, and/or (iii) performing any other methods.

At operation 310, at least a portion of computer implemented services may be provided by the hardware resources and using the at least one of the required applications. The at least a portion of computer implement services may be provided via (i) ingesting, by the hardware resources, at least of the required applications (e.g., application data), (ii) performing the computer implemented services by the hardware resources, and/or (iii) performing any other methods.

The method may end following operation 310.

Using the methods illustrated in FIG. 3, embodiments disclosed herein may provide systems and methods usable to manage operations of data processing systems by implementing control policies corresponding to different occurrences of policy management events using out-of-band methods. By implementing control policies, a desired state for a discrete graphics component may be identified and operation of the discrete graphics component may be updated based on the desired state. By updating operation of the discrete graphics component, computer implemented services that confirm to the limits specified by the control policies may be provided.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein.

Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order.

Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
identifying, by a management controller of the data processing system, that a software compliance event for hardware resources of the data processing system has occurred;
based on the identifying of the software compliance event:
identifying, by the management controller and using an observability entity, a list of applications hosted by the hardware resources;
comparing, by the management controller, the list of applications to a required list of applications to identify whether any required applications are not hosted by the hardware resources;
in an instance of the comparing where at least one of the required applications is not hosted by the hardware resources:
initiating, by the management controller, installation of at least one of the required applications that is not hosted by the hardware resources to place the hardware resources into compliance with the required applications; and
providing, by the hardware resources, at least a portion of computer implemented services using the at least one of the required applications.

2. The method of claim 1, wherein the required list of applications is based on applications installed on the hardware resources when the data processing system is manufactured.

3. The method of claim 2, wherein the identifying that the software compliance event is performed after the data processing system is sold by a manufacturer to an end user.

4. The method of claim 3, wherein the end user is a legal entity, and an onboarding process is performed by an agent of the legal entity to initiate use of the data processing system by the end user.

5. The method of claim 4, wherein the onboarding process comprises removing, at least, the at least one of the required applications from hosting by the hardware resources.

6. The method of claim 1, further comprising:
after the identifying the occurrence of the software compliance event and prior to identifying the list of applications:
initiating, by the management controller, performance of a conversion of natively hosted applications by the hardware resources to hosting in a new virtual entity.

7. The method of claim 6, wherein identifying the list of applications comprises:
reading, by the observability entity, an image of the new virtual entity to identify each application hosted by the new virtual entity.

8. The method of claim 7, wherein the occurrence of the software compliance event is a startup of the data processing system after completing onboarding to a domain of a new owner of the data processing system.

9. The method of claim 7, wherein the new virtual entity is a virtual machine, the reading of the image is facilitated by a hypervisor hosted by the hardware resources, and the hypervisor is adapted to manage resource access by the virtual machine and the observability entity.

10. The method of claim 1, wherein the data processing system comprises a network module adapted to separately advertise network endpoints for the management controller and the hardware resources of the data processing system, the network endpoints being usable by a server to address communications to the hardware resources using an in-band communication channel and the management controller using an out-of-band communication channel.

11. The method of claim 10, wherein the management controller and the network module are on separate power domains from the hardware resources so that the management controller and the network module are operable while the hardware resources are inoperable.

12. The method of claim 10, wherein the out-of-band communication channel runs through the network module, and the in-band communication channel that services the hardware resources also runs through the network module.

13. The method of claim 10, wherein the network module hosts a transmission control protocol/internet protocol (TCP/IP) stack to facilitate network communications via the out-of-band communication channel.

14. A non-transitory machine-readable medium having instructions stored therein, which when executed by a processor, cause the processor to perform operations for managing operation of a data processing system, the operations comprising:
identifying, by a management controller of the data processing system, that a software
compliance event for hardware resources of the data processing system has occurred;
based on the identifying of the software compliance event:
identifying, by the management controller and using an observability entity, a list of applications hosted by the hardware resources;
comparing, by the management controller, the list of applications to a required list of applications to identify whether any required applications are not hosted by the hardware resources;
in an instance of the comparing where at least one of the required applications is not hosted by the hardware resources:
initiating, by the management controller, installation of at least one of the required applications that is not hosted by the hardware resources to place the hardware resources into compliance with the required applications; and
providing, by the hardware resources, at least a portion of computer implemented services using the at least one of the required applications.

15. The non-transitory machine-readable medium of claim 14, wherein the list of required applications is based on applications installed on the hardware resources when the data processing system is manufactured.

16. The non-transitory machine-readable medium of claim 15, wherein the identifying that the software compliance event is performed after the data processing system is sold by a manufacturer to an end user.

17. The non-transitory machine-readable medium of claim 16, wherein the end user is a legal entity, and an onboarding process is performed by an agent of the legal entity to initiate use of the data processing system by the end user.

18. A data processing system, comprising:
a processor; and
a memory coupled to the processor to store instructions, which when executed by the processor, cause the processor to perform operations for managing operation of the data processing system, the operations comprising:
identifying, by a management controller of the data processing system, that a software compliance event for hardware resources of the data processing system has occurred;
based on the identifying of the software compliance event:
identifying, by the management controller and using an observability entity, a list of applications hosted by the hardware resources;
comparing, by the management controller, the list of applications to a required list of applications to identify whether any required applications are not hosted by the hardware resources;
in an instance of the comparing where at least one of the required applications is not hosted by the hardware resources:
initiating, by the management controller, installation of at least one of the required applications that is not hosted by the hardware resources to place the hardware resources into compliance with the required applications; and
providing, by the hardware resources, at least a portion of computer implemented services using the at least one of the required applications.

19. The data processing system of claim 18, wherein the list of required applications is based on applications installed on the hardware resources when the data processing system is manufactured.

20. The data processing system of claim 19, wherein the identifying that the software compliance event is performed after the data processing system is sold by a manufacturer to an end user.
